(19) United States
(12) Patent Application Publication
(10) Pub. No.: US 2005/0005259 A1
(43) Pub. Date: Jan. 6, 2005

(54) System and method for communication and mapping of business objects between mobile client devices and a plurality of backend systems

(75) Inventors: Gary Kevin Avery, South Riding, VA (US); Randall W. Brouckman, Oakton, VA (US); John Gardner Cleary, Herndon, VA (US); Abraham Issachar Reifer, Silver Spring, MD (US); Lance Bennett Devin, Vienna, VA (US)

Correspondence Address: FOLEY & LARDNER, 777 EAST WISCONSIN AVENUE, SUITE 3800, MILWAUKEE, WI, 53202-5308, US

(73) Assignee: Infowave Software, Inc.

(21) Appl. No.: 10/801,488

(22) Filed: Mar. 15, 2004

Related U.S. Application Data
(60) Provisional application No. 60/454,350, filed on Mar. 14, 2003.

(51) Int. Cl. G06F 9/44

(52) U.S. Cl. 717/103; 717/102; 717/101

(57) ABSTRACT

A system for communication and mapping of business objects between a mobile client device and a plurality of backend systems via a network includes a mobile server and a mobile client device in data communication with the mobile server. The mobile server includes a process automation engine, a communication module coupled to the process automation engine and a presentation module coupled to the process automation engine and the communication module. The process automation engine is configured to map business objects to a plurality of backend systems and includes a plurality of mobile business processes where each mobile business process defines a flow and exchange of business objects between the mobile client device and at least one of the plurality of backend systems. The communication module is configured to receive and transmit business objects between the mobile client device and at least one of the plurality of mobile business processes via the network. The presentation module is configured to define a dynamic user interface based on at least one mobile business process. The dynamic user interface is configured to integrate the business objects and the at least one mobile business process. The mobile client device includes a thick client application in data communication with the communication module and configured to receive the business objects and the definition of the dynamic user interface. The thick client application is also configured to generate the dynamic user interface to facilitate viewing and modifying the business objects.

### CROSS-REFERENCE TO RELATED PATENT APPLICATIONS

This application claims benefit under 35 USC 119(e) of U.S. Provisional Patent Application Ser. No. 60/454,350, filed Mar. 14, 2003, entitled “System and Method for Wireless Solutions to Plant Management, Sales Force Automation and Field Force Automation Including Distributed Components for Implementing Same,” herein incorporated by reference in its entirety.

### FIELD OF THE INVENTION

The present invention relates generally to the field of data communication and computer networks including mobile devices and more particularly, to a system and method for communication and mapping of business objects between mobile client devices and a plurality of enterprise backend systems.

### BACKGROUND OF THE INVENTION

Many enterprises or business organizations include a mobile workforce, i.e., workers/employees who work remotely or from the road. For example, employees may do work at a customer or at the location of an asset or plant using mobile devices, e.g., mobile phones, PDAs (personal digital assistant), other handheld computers, laptop or portable computers, etc. Mobile workers may need to access a variety of enterprise systems to perform day-to-day operations. A mobile worker may need to access data from enterprise backend systems such as Supply Chain Management (SCM), Customer Relationship Management (CRM), Enterprise Resource Planning (ERP), Enterprise Asset Management (EAM), Field Services Automation (FSA), etc. Such systems are designed to help enterprises preserve, protect and extend the life of capital assets and increase operational efficiencies. Typically, however, these systems are disparate or non-integrated and data for such systems reside in different databases.

Many prior systems provide mobile access to backend systems by providing a “mobile” version of a backend application on a mobile device. For example, a transcoder or mobile solution may be placed on top of a solution that was designed for a PC or a terminal to deliver a mirrored or replicated version of the backend application on a mobile device. If a mobile user, however, needs to access data from more than one backend system, a different mobile version of each backend application may be required to access the data. Such non-integrated solutions to enterprise mobility limit the type and amount of data that can be accessed by a mobile user.

Thus, there is a need for a mobile access solution that provides workflows for a mobile end user across multiple business operations, whereby the flow and transformation of data between a mobile client and different backend systems can be defined. It would also be advantageous to provide a mobile access system that provides access to data from multiple backend systems using a single application on a mobile device. It would also be advantageous to provide a system and method for communication and mapping of business objects between a mobile client device and a plurality of enterprise backend systems.

The teachings hereinbelow extend to those embodiments which fall within the scope of the appended claims, regardless of whether they accomplish one or more of the aforementioned needs.

### SUMMARY OF THE INVENTION

In accordance with an embodiment, a system for communication and mapping of business objects between a mobile client device and a plurality of backend systems via a network includes a mobile server and a mobile client device in data communication with the mobile server. The mobile server includes a process automation engine configured to map business objects to the plurality of backend systems and including a plurality of mobile business processes, each mobile business process defining a flow and exchange of business objects between the mobile client device and at least one of the plurality of backend systems, a communication module coupled to the process automation engine, the communication engine configured to receive and transmit business objects between the mobile client device and at least one of the plurality of mobile business processes via the network, a presentation module coupled to the process automation engine and the communication module, the presentation module configured to define a dynamic user interface based on at least one mobile business process, the dynamic user interface configured to integrate the business objects and the at least one mobile business process. The mobile client device includes a thick client application in data communication with the communication module, the thick client application configured to receive the business objects and the definition of the dynamic user interface and configured to generate the dynamic user interface to facilitate viewing and modifying of the business objects.

In accordance with another embodiment, a method for communication and mapping of business objects between a mobile client device and a plurality of backend systems via a network includes providing a plurality of mobile business processes, each mobile business process defining a flow and exchange of business objects between the mobile client device and at least one of the plurality of backend systems, defining a dynamic user interface based on at least one mobile business process, the dynamic user interface configured to integrate the business objects and the at least one mobile business process, transmitting the dynamic user interface definition and business objects to the mobile client device and generating the dynamic user interface on the mobile client device to facilitate viewing and modifying of the business objects.

### BRIEF DESCRIPTION OF THE DRAWINGS

The invention will be more readily understood by reference to the following description taken with the accompanying drawings, in which:

FIG. 1 is a schematic block diagram of a system for communication and mapping of business objects between mobile client devices and a plurality of backend systems in accordance with an embodiment.

FIG. 2A is a schematic block diagram of a mobile client device of FIG. 1 in more detail in accordance with an embodiment.

FIG. 2B is a schematic block diagram of a mobile client device of FIG. 1 in more detail in accordance with an alternative embodiment.

FIG. 3 is a schematic block diagram of a mobile server of FIG. 1 in more detail in accordance with an embodiment.

FIG. 4 is schematic block diagram of the application server of FIG. 3 in more detail in accordance with an embodiment.

FIG. 5 illustrates an exemplary business process definition in accordance with an embodiment.

FIG. 6 shows an exemplary mapping of data from a backend system to mobile business objects for a mobile client device in accordance with an embodiment.

FIG. 7 illustrates a method for communication and mapping of business objects between mobile client devices and a plurality of backend systems in accordance with an embodiment.

### DETAILED DESCRIPTION OF THE PREFERRED EMBODIMENTS

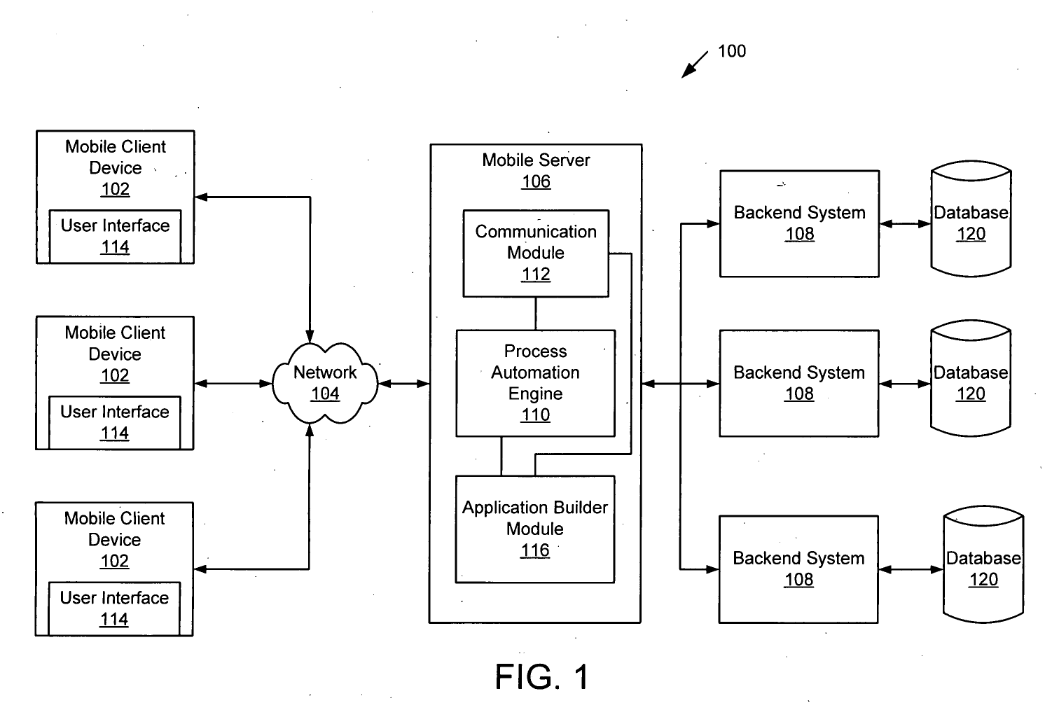

FIG. 1 is a schematic block diagram of a system for communication and mapping of business objects between mobile client devices and a plurality of backend systems in accordance with an embodiment. System 100 includes mobile client devices 102 in data communication with a mobile server 106 via a network 104. Mobile server 106 is coupled to and in data communication with a plurality of backend systems 108, each having a database 120 for storage of data. System 100 is configured to communicate and map (or transform) business objects (including data) between a mobile client device 102 and the plurality of backend systems 108 and vice versa. Mobile server 106 and backend systems 108 may be a computer server or any other device capable of storing information and communicating with a network 104. Mobile client device 102 may be, for example, a mobile telephone, a handheld PDA (Personal Digital Assistant), a handheld computer, a laptop computer, or any other mobile computing device, etc. Backend systems 108 may be enterprise systems such as Supply Chain Management (SCM), Customer Relationship Management (CRM), Enterprise Resource Planning (ERP), Enterprise Asset Management (EAM), Field Services Automation (FSA), legacy systems, databases, work management, dispatch, financials, manuals, etc. or systems external to the enterprise such as e-commerce, business-to-business transactions such as purchasing, etc. Backend systems 108 may be disparate and non-integrated. Accordingly, system 100 is configured to enable a user of a mobile client device to access data distributed across backend systems 108 and the corresponding databases 120.

In at least one embodiment, a computer system is used which has a processing unit or central processing unit (CPU) that executes sequences of instructions contained in memory. More specifically, execution of the sequences of instructions causes the CPU to perform steps which are described below. The instructions may be loaded into random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any specific combination of hardware circuitry and software, nor to any particular source for the instructions executed by the computer system.

As used herein, the term “business operation” refers to an essential set of enterprise functions that enable the planning, execution and tracking of activities that help capital- and asset-intensive organizations to automate and optimize efficiency within an organization. The term “business process” refers to a process that defines the activities, flow and order of accessing, reporting and utilizing enterprise data. The term “mobile business process” refers to a process that defines the optimal application flow or workflow, activities, or order of accessing, reporting and utilizing data for a mobile device. Workflows define how different tasks that a mobile user must perform and the data associated with the tasks are collected, transformed and integrated with various backend systems.

Returning to FIG. 1, network 104 may be any type of network such as a virtual private network, the Internet, an intranet, an Ethernet, etc. Network 104 preferably operates in accordance with the TCP/IP (Transmission Control Protocol/Internet Protocol) protocol. Network 104 may use a network connectivity protocol such as 802.11b, CDMA (Code Division Multiple Access), TDMA (Time Division Multiple Access), GRPS, CDPD (Cellular Digital Packet Data), GSM (Global System for Mobile communication), Link & Sync, etc. Further, network 104 may be configured as a wireless or wired network. Communication of business objects between a mobile client device 102 and mobile server 106 via network 104 may be a synchronous communication or an asynchronous communication. Network 104 may be configured to provide communication with web pages formatted using, for example, HTML (Hypertext Markup Language), dHTML (dynamic HTML), XML Extensible Markup Language), HDML (Handheld Device Markup Language), WML (Wireless Markup Language), pXML (presentation Extensive Markup Language), etc. Alternatively, network 104 may be configured to provide communication via asynchronous messaging protocols such as JMS (Java Message Service) or RPC Remote Procedure Call) protocols such as SOAP (Simple Object Access Protocol).

Mobile server 106 includes a process automation engine 110, a communication module 112 and an application builder 116. Preferably, the architecture of mobile server 106 is a Java- and XML-based server architecture. Mobile server 106 does not have to be physically embodied in a computer, but can be any combination of hardware and software performing a server function in a client/server relationship. As a person of skill in the art would appreciate, there can be one centralized server or several distributed ones. Process automation engine 110 includes a plurality of mobile business processes that define the workflow or flow and transformation (or mapping) of business objects (including data) between a mobile client device 102 and the plurality of backend systems 108. A workflow defines how different tasks and the data associated with the tasks are collected, transformed and integrated with various backend systems. Process automation engine 110 executes the business processes. Data and business objects to be exchanged between a mobile client device and the plurality of backend systems based on the execution of a business process may need to be converted between formats, i.e., business objects may need to be transformed to be in the proper format for the backend systems or the mobile client device. Accordingly, process automation engine is further configured to map business objects between a mobile client device and a backend system or systems and vice versa. Communication of business objects between a mobile server 106 and backend systems 108 may be a synchronous communication or an asynchronous communication.

The mobile business processes may include, for example, processes for field service (e.g., send and receive work orders, document service calls on-site, order parts, etc., field sales (e.g., access to forecasting, account planning and calculation commissions, access account information, etc.), maintenance repair and overhaul (MRO) (e.g., view and update outstanding maintenance items, access part and equipment availability, etc.), enterprise asset management, direct store delivery, plant maintenance, etc. Each mobile business process may access or invoke one or more backend systems 108. For example, client data associated with a first backend system that is used to drive a mobile business process may invoke a call to a second backend system to retrieve data required for the mobile business process. Accordingly, the mobile business processes and process automation engine 110 are configured to enable access to the plurality of backend systems 108. Further, each mobile business process included in process automation engine 110 is preferably configured to integrate with the other mobile business processes. In one embodiment, a business process may be an off-the-shelf, configurable application. Process automation engine 110 may also be an off-the-shelf, configurable application, capable of executing business processes encoded in a proprietary or industry standard format. A business process within the process automation engine 110 may also be associated with and invoked by a dynamic user interface definition that may be provided via communication module 112 and network 104 to the user interface 114 of a mobile client device 102.

Communication module 112 is configured to receive and transmit business objects between a mobile client device 102 and a mobile business process or processes included in the process automation engine 110. In addition, communication module 112 is configured to marshall business objects between a mobile client device and a mobile business process of the process automation engine 110. Communication module 112 may be configured to communicate with the Internet, etc. and may utilize a variety of secure transmission techniques such as virtual private networks (VPN), SSL (Secure Socket Layer), http/s, to encrypt and decrypt data. Further, communication module 112 may be configured to optimize mobile communications, e.g. transmission of data via a wireless network, using technologies such as data compression using known data compression techniques such as GZIP, tinyXML, etc. Compression may be required for a lower bandwidth network, such as a wireless network. Alternatively, compression may be used to optimize transfers of large documents or amounts of data.

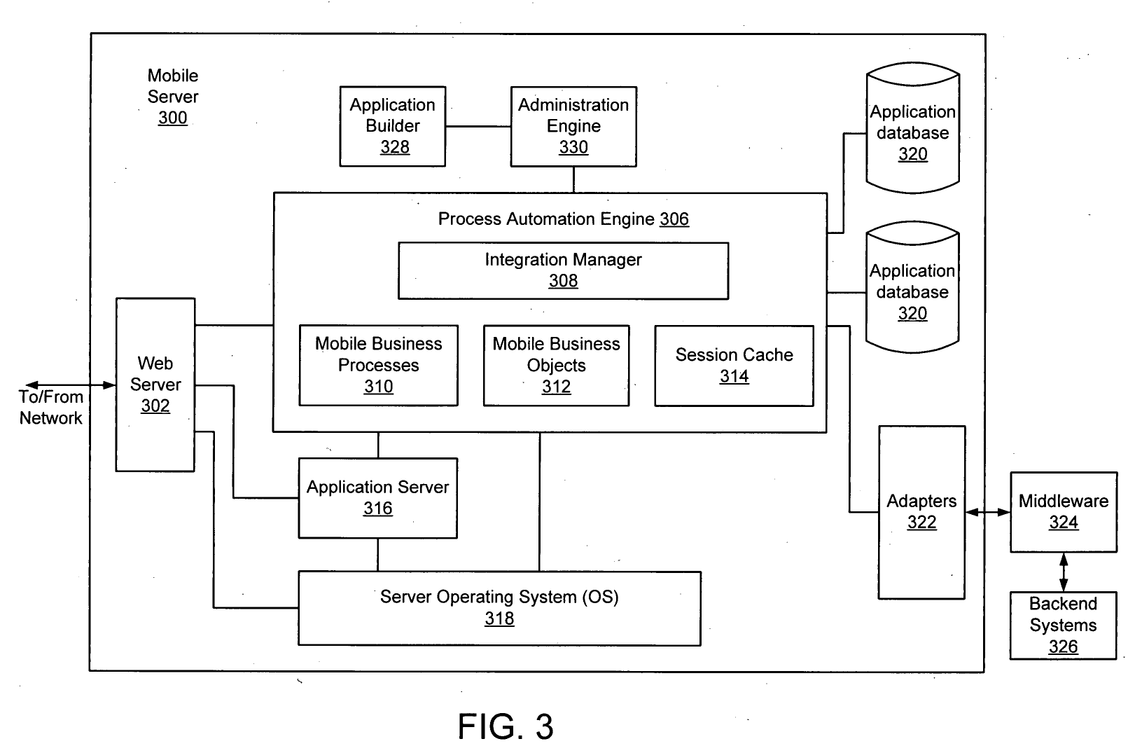

Application builder 116 is configured to allow a user (e.g., an administrator of the mobile server 106) to create dynamic and automated forms and define data validation rules that may be used in conjunction with (or integrated with) a business process or processes from the process automation engine 110. Accordingly, an administrative module (shown in FIG. 3) may be included in the mobile server 106 and configured to provide a user interface to create forms and validation rules as well as to configure mobile business processes included in the process automation engine 110. Forms and data validation rules created using application builder 116 may be stored in a central database (not shown). Alternately, a dynamic user interface may be predefined and stored in a central location such as on a web server or a central database. Application builder 116 may also be used to create routes or form sequences which may be used to drive a centralized forms definition. The forms definitions may define a user interface or an application to be run on a mobile client device to facilitate the capture of data to drive a business process. Mobile server 106 may provide the appropriate forms to a mobile client device 102 based on the currently executed mobile business process. Alternatively, the forms may be retrieved by the mobile client device 102 in advance of executing a business process. In addition, application builder 116 may be configured to create tables, which may be stored in a central database, based on the data received using the dynamic forms on the mobile client device 102. The data validation rules allow the data entered by a user in a form at the mobile client device to be validated locally at the point of work, before the data is sent to the backend systems 108. For example, the data validation rules may prevent a user from completing a form incorrectly or sending an incomplete form.

Each mobile client device 102 includes a user interface 114. In one embodiment, user interface 114 is part of a thin client application, e.g., a Wireless Application Protocol (WAP) or Internet capable Web browser (e.g., Netscape or Microsoft Internet Explorer, etc.) on the mobile client device 102. In an alternative embodiment, user interface 114 is part of a thick client application on the mobile client device 102, i.e., an application that is configured to allow processing even when the mobile client device 102 is not connected to network 104. Accordingly, the thick client application is configured to render a dynamic user interface to, for example, view or modify business objects on the mobile client device. Preferably, user interface 114 on the mobile client device is written using known industry standard user interface development languages, e.g., HTML, JavaScript, Java Server Pages (JSP), a scripting language, a compiled module, etc. The user interface 114 or client application is configured to enable a user of the mobile client device to view, update and access the relevant business objects and data from backend systems 108. As discussed above, in one embodiment, a user interface or client application may be based on forms or a forms definition distributed by mobile server 106.

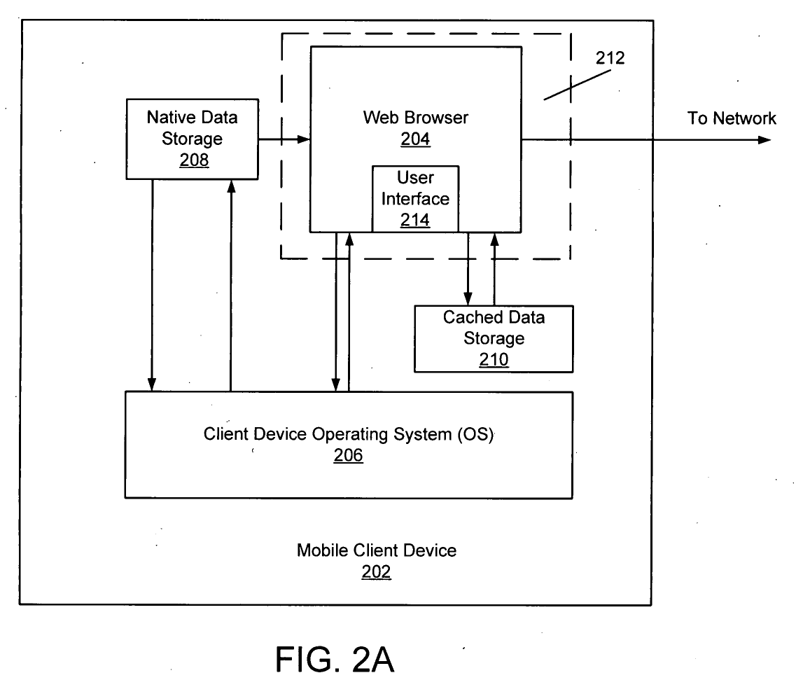

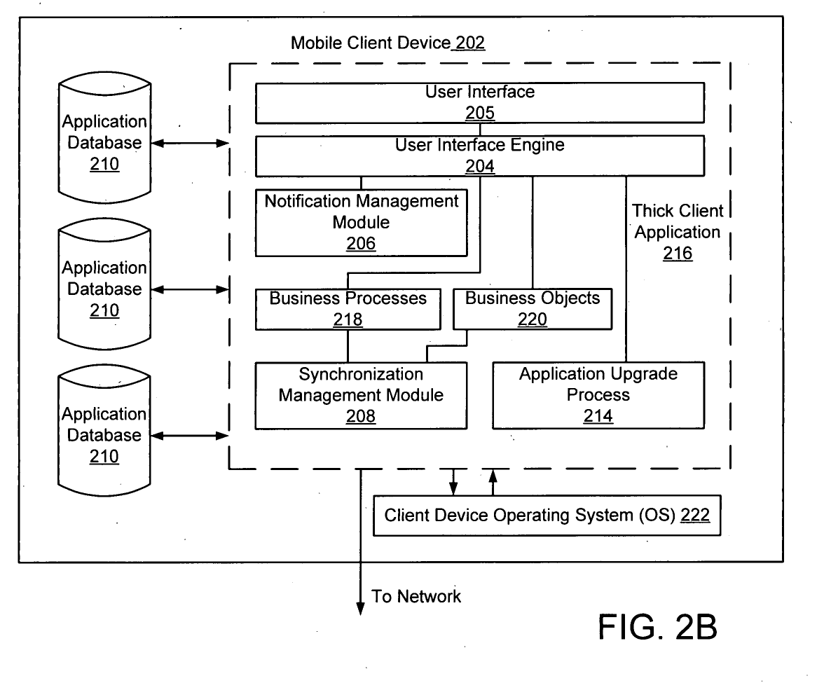

FIG. 2A is a schematic block diagram of a mobile client device of FIG. 1 in more detail in accordance with an embodiment. In particular, FIG. 2A shows a mobile client device 202 including a thin client application 212 for accessing the mobile server 106 (shown in FIG. 1) via a network. As discussed above, a thin client application refers to a WAP (Wireless Internet Protocol) or Internet capable Web browser. Accordingly, thin client application 212 includes a Web browser 204 that is used to provide a dynamic user interface 214. As mentioned above, preferably, user interface 214 is written using known industry standard user interface development languages, e.g., HTML, JavaScript, etc. Web browser 204 may be connected to the mobile server 106 (FIG. 1) via a wireless or wired network. Mobile client device 202 also includes a client device operating system 206 (e.g., Windows CE), native data storage 206 and cached data storage 210. Typically, thin client access is made from a mobile client device that does not have the capability to store large amounts of data in a database or install and run custom applications (other than via the Web browser 204). It should be understood, however, that a mobile client device having such capabilities may also be configured to access the mobile server via a thin client application 212. Thin client application 212 is typically operated in a connected mode, i.e., the Web browser is connected to the wireless or wired network.

When web browser 204 is connected to the mobile server via a network, thin client application 212 is a collection of markup language web documents formatted for the particular device requirements (i.e., HTML, HDML, WML, XML). User interface 214 may include both graphical and text based content. Cached data storage 210 may be configured to store web or WAP pages. Thin client application 212 is primarily responsible for the presentation and formatting of data returned from the mobile server per requests made by the mobile client device 202 when, for example, a user selects menu options or presses web document buttons via the Web browser 204 and user interface 214. Features of the user interface 214, in particular the workflow or presentation of screens, is provided from a process automation engine (shown in FIG. 1) of the mobile server based on a mobile business process and the business objects (including data) provided or requested by a user. The thin client application 212 enables a user to navigate from screen to screen and make requests of the mobile server for each step of the navigation.

Preferably, thin client application 212, in conjunction with the mobile server, is configured to provide authentication and authorization for a user. When a user of the mobile client device 202 invokes the web browser 204 and connects to the mobile server, the user is prompted via user interface 214 to provide a login ID and a password. The login ID and password entered by the user will be checked in real-time against the information stored in a directory server (described below) coupled to the mobile server. Communication between the thin client application 212 and the mobile server may be protected by use of encryption, such as WTLS (Wireless Transport Layer Security) and/or SSL (Secure Sockets Layer). Once a user is authenticated (i.e., using the login ID and password) to the mobile server, the transactions or functions the user may perform are based upon authorization rules stored in a directory server (not shown) coupled to the mobile server.

FIG. 2B is a schematic block diagram of a mobile client device of FIG. 1 in more detail in accordance with an alternative embodiment. In particular, FIG. 2B shows a mobile client device 202 including a thick client application 216 for accessing the mobile server 106 (shown in FIG. 1) via a network. Mobile client device 202 may be connected to the mobile server (not shown) via a wireless or wired network. Thick client application 216 is configured to allow a user of the mobile client device 202 to process data and business objects even when the mobile client device 202 is not connected to the network. Accordingly, thick client application provides functionality so that mobile business processes may be supported locally without connection to the mobile server. As mentioned above, preferably, dynamic user interface 205 is written using known industry standard user interface development languages, e.g., HTML, JavaScript, XML, etc. Thick client application 216 is configured to perform a plurality of functions including presentation and formatting of data, managing persistence of locally cached data, synchronizing the data with the mobile server when network connectivity is available and handling application upgrades and data conversion requirements for version control.

Mobile business processes 218 (or workflows) are stored locally on mobile client device 202 as well as business objects 220. Business processes 218 may be encapsulated within the dynamic user interface 205 or may be predefined within thick client application 216. Mobile client device 202 is configured to store data resulting from the business processes in, for example, an application database 210. Accordingly, persistent data storage and local caching of business objects is provided on the mobile client device 202. Business object framework 220 is configured to provide a set of persistent business objects that may be used for interpreting the data stored in database(s) 210. Accordingly, business object framework 220 acts as an access layer between the user interface engine 204 and the database(s) 210. Business object framework 220 may also be configured to marshall, serialize and unmarshall functions between database(s) 210 and a synchronization management module 208 that is configured to interface with and synchronize data with the mobile server (and, therefore, backend systems) when the mobile client device 202 is connected to the network.

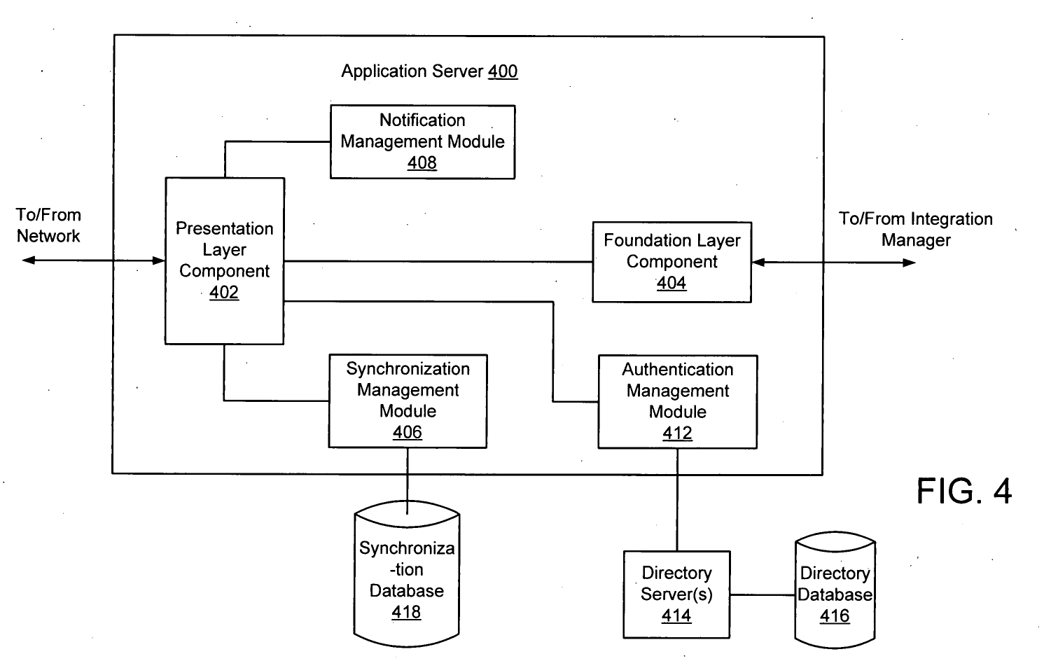

A user interface engine 204 is provided to render and execute a dynamic user interface 205 to receive and display data based on the workflow of a mobile business process or processes 218. User interface engine 204 is configured to perform functions such as drawing the client screens and controlling the flow of operations between screens based on information stored in the database(s) 210 and the workflow of the mobile business processes 218. Information regarding layout and screens for the user interface 205 may be stored in an application database 210 or alternatively, as files accessible by the client device operating system 222. User interface engine 204 is also configured to make the appropriate calls to the business objects 220 and synchronization management module 208 to retrieve and store data locally and remotely. In one embodiment, thick client application 216 invokes a synchronization management module framework (shown in FIG. 4) on the mobile server to synchronize and reconcile data cached locally on the device against the current data in the backend systems. In an alternative embodiment, thick client application 216 makes requests while the mobile client device 202 has network connectivity to the mobile server.

Thick client application 216 also includes an application upgrade process 214 that is configured to allow the update of the thick client application 216 and database schemas and application database(s) 210. Application database(s) 210 may contain multiple tables used to: 1) drive the user interface engine 204 and user interface 205; 2) drive the business process flow of a business process 218; 3) store business data; 4) support configuration of the thick client application 216; and 5) support security for the thick client application 216. In addition, database(s) 210 may be configured to store other data necessary to support other functions. Mobile client device 202 also includes a client device operating system 222 (e.g., Windows CE).

As mentioned above, the thick client application 216 is configured to operate in a disconnected mode (i.e., the mobile client device 202 is not connected to a network). Accordingly, thick client application 216 includes synchronization management module 208 that is configured to provide a framework to perform the client side functions necessary to transmit data to and from the mobile server. Synchronization management module 208 is configured to transmit one or more business objects without concern for the format of the business objects. Synchronization management module 208 interfaces with the business object framework 220 for translation, marshalling, serializing and unmarshalling of business objects. To perform synchronization, the mobile client device 202 must be connected to the mobile server via a network. Synchronization may occur automatically as a result of the direction of the thick client application 216 or on demand. Once connected to the network and mobile server, synchronization management module 208 on the mobile client device 202 performs an authentication handshake with a synchronization management module (not shown) of the mobile server. The authentication may be based on the login ID and password provided by a user. Preferably, the user only needs to enter a login ID and password once, i.e., to log in to the thick client application 216 on the mobile client device 202. Once the authentication is successful, synchronization management module 208 may, for example, exchange HTTP messages between the mobile client device 202 and the mobile server to perform business object/data transfers. Synchronization management module 208 is configured to synchronize data from database(s) 210 on the mobile client device 202 with backend system data. Database records that have been changed may be identified using an indicator (e.g., “dirty bits”) stored in a field in the database record. Business objects that have changed locally or have been placed into a synchronization management module framework on the mobile server for delivery to a particular user may be exchanged between the mobile client device 202 and the mobile server during synchronization. Business objects on the mobile client device 202 are used to direct the synchronized data obtained by the synchronization management module 208 from the mobile server into the appropriate database(s) 210.

Application upgrade process 214 is configured to check for and perform updates of the thick client application 216. Thick client application 216 and its components are configured to maintain inventory version information in a local registry. When mobile client device 202 is synchronizing with the mobile server, the registry entries for each application and component will be set with the most recent release available. When the thick client application 216 is started next, it will check its entry in the registry to determine if an upgrade is available. If so, the user of the mobile client device 202 may be prompted via user interface 205 whether to upgrade the application. If the user selects to upgrade the application, then the application upgrade process is invoked. In an alternative embodiment, an application upgrade may be completed automatically via the application upgrade process 214 Once an application upgrade is complete, the registry entry for the application is updated to indicate the installation of the upgrade.

Notification management module 206 is configured to provide a framework for receiving notifications (or messages) from the mobile server. Notifications (or messages) may be sent in response to events and may be sent by the mobile server or other sources (e.g., the backend systems). Notification management module 206 is configured to receive or reject messages via the synchronization management module 208. In addition, an acknowledgement of messages received may be provided to the mobile server. A notification may be sent to a particular user (or mobile client device) via the synchronization management module framework as messages. Alternatively, the notification management module may be configured to receive e-mail messages provided through a standard e-mail application. In one embodiment, the mobile client device has an SMS network address and the mobile client device 202 may receive SMS messages. Thick client application 216 may be configured to allow a user to select the type of notification mechanism.

Preferably, thick client application 216, in conjunction with the mobile server, is configured to provide authentication and authorization for a user. When the mobile client device 202 is initially accessed, a user is prompted for a logon ID and a password. The login ID and password entered by the user will be checked in real-time against the stored authentication information. Since the mobile client device 202 may not be connected to a network (and thus the mobile server), authentication may be performed using local data that is stored in an encrypted form on the mobile client device 202. The logon ID and password are subsequently used by the thick client application 216 to authenticate to the mobile server during synchronization and application upgrade events. Communications between the thick client application 216 and the mobile server may be protected by use of encryption, such as WTLS and/or SSL, virtual private networks, etc. Once a user is authenticated (i.e., using the login ID and password) to the mobile server, the transactions or functions the user may perform are based upon authorization rules stored in a directory server (not shown) coupled to the mobile server.

FIG. 3 is a schematic block diagram of a mobile server of FIG. 1 in more detail in accordance with an embodiment. Mobile server 300 includes a web server 302, a process automation engine 306, an application server 316, an application builder 328, and an administration engine 330: Mobile server also includes a server operating system (OS) 318 (e.g., UNIX, NT, etc). Web server 302 is configured to provide communications via a network, for example, the Internet. Process automation engine 306 includes an integration manager 308 that may be used to define and execute process automation sequences for logic and data transformations triggered by data and business objects received from a mobile client device (not shown) or backend system 326. Integration manager 308 may be an off-the-shelf configurable business process engine. Integration manager 308 is configured to automatically define and/or configure business objects and mobile business processes or to enable a user to define and/or configure business objects and mobile business processes. Administration engine 330 may be configured to provide a user interface for a user to view, define and configure mobile business objects 312 and mobile business processes 310. The configuration logic used to configure mobile business objects 312 and mobile business processes 310 may be defined using proprietary or industry standard workflow markup.

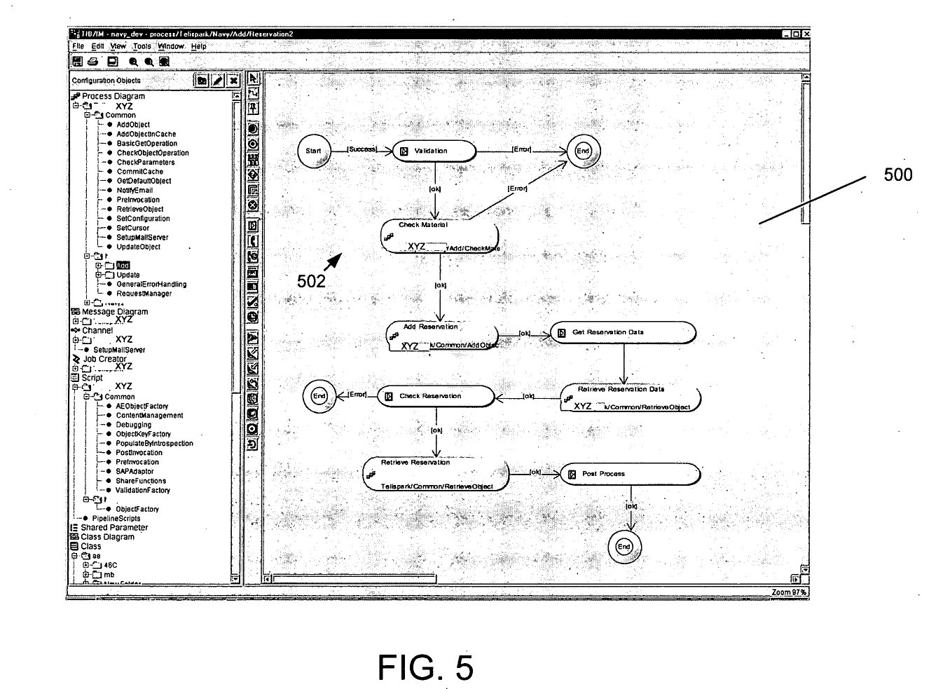

As discussed above, process automation engine 306 includes a plurality of mobile business processes 310 that define the workflow or flow and transformation (or mapping) of business objects (including data) between a mobile client device (not shown) and a plurality of backend systems 326 and vice versa. Mobile business processes 310 may include, for example, processes for field service, field sales, maintenance repair and overhaul (MRO), enterprise asset management, direct store delivery, plant maintenance, etc. Each mobile business process may require access to one or more backend systems 326. Accordingly, mobile business processes 310 and process automation engine 306 are configured to enable access to the plurality of backend systems 326. Further, each mobile business process included in process automation engine 306 is preferably configured to integrate with the other mobile business processes. A mobile business process may also be configured or designed via a user interface of the integration manager 308. The user interface may be provided via, for example, an administration engine 330 coupled to the integration manager 330. In one embodiment, a business process consists of script tasks, signal tasks and decision flows. FIG. 5 illustrates an exemplary business process definition in accordance with an embodiment. A user interface 500 may be provided to configured and view a business process 502. Business process 502 may be defined in a proprietary language, e.g. a language proprietary to integration manager 308, or may be based on an industry standard workflow markup, such as BPEL (Business Process Execution Language) and BPML (Business Process Modeling Language). A business process may include both automatic activities (or logic) and conditional activities (or logic). Business process 502 defines a workflow including a plurality of tasks. A task within business process 502 may require access to a backend system. Data or a business object may need to be transformed or mapped to the data or business object is in the proper format for the backend system. Alternatively, a transformation or mapping may be required for data to be sent from a backend system to a mobile client device. Business process 500 is configured to access or invoke a single backend system, however, in alternative embodiments, a business process may be configured to access or invoke a plurality of backend systems. For example, client data associated with a first backend system may trigger the business process to call a second backend system to retrieve data required for the business process.

Process automation engine 306 also includes mobile business objects 312 and a session cache 314. Business objects 312 may define data such as Customer, Order, Line Item, Product, that relate to information required for a mobile business process. When a request that results in accessing data from a backend system 326 is generated, a business object may be constructed if it is the first time the data or business object is requested. A business object is created based on the data from the backend system 326 and may be stored in the business object cache 312. When a business object is accessed subsequently, the business object is restored in the cache 312. Session cache 314 is configured to store business objects that are required to maintain a context for a session.

As discussed above with respect to FIG. 1, application builder 328 is configured to allow a user (e.g., an administrator of the mobile server 300) to create dynamic and automated forms and define data validation rules that may be used in conjunction with (or integrated with) a mobile business process or processes from the process automation engine 110. Accordingly, administration engine 330 may be configured to provide a user interface to create forms and validation rules as well as to configure mobile business processes included in the process automation engine 308. Adapters 322 are configured to enable integration with middleware 324 and backend systems 326. Adapters 322 enable communication of data and business objects between the mobile server 300 and backend systems 326. Adapters 322 are configured to be an interface point between the integration manager 308 and backend systems 326.

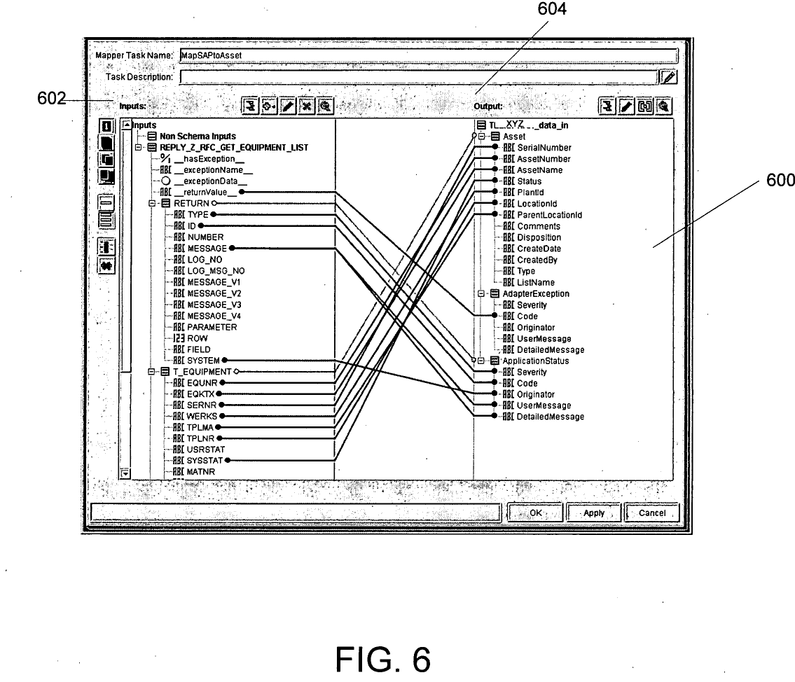

Process automation engine 308 is also configured to map business objects between a mobile client device (not shown) and backend systems 326. FIG. 6 shows an exemplary mapping of a mobile business object to backend systems in accordance with an embodiment. Preferably, a graphical mapper 600 (as shown in FIG. 6) is provided to enable integration to the different backend systems 326. The required data (inputs 602) from a first backend system, for example SAP, is mapped to business objects (outputs 604) that may be transmitted to a mobile client device. FIG. 6 illustrates an exemplary mapping of a task within a business process or workflow. Business objects or data may be mapped in a similar manner for transfer from a mobile client device to a backend system. Various workflows and transformations between a mobile client device and a plurality of backend systems may be defined using the methodology described with respect to FIGS. 5 and 6. In addition, the business object may be used to drive a mobile business process from the process automation engine 308 and specific data used in the mobile business process may trigger a request for data from a second backend system that may affect the business objects and data returned to the first backend system and/or the mobile client device.

Returning to FIG. 3, mobile server 300 also includes an application server 316. FIG. 4 is schematic block diagram of an application server of FIG. 3 in more detail in accordance with an embodiment. Application server 400 includes a presentation layer component 402, a foundation layer component 404, a synchronization management module 406, a notification management module 408, and an authentication management module 412. Presentation layer component 402 is configured to be the point of entry for all requests made of the mobile server (shown in FIG. 3) from mobile client devices including those made by thick client applications and those made by thin client applications. Presentation layer component 402 is configured to manage all aspects of handling users, sessions, mobile client devices, data formats (including translation of data formats) and other factors that affect content generation and manipulation of data received from mobile client devices and retrieved from backend systems. In one embodiment, the presentation layer component 402 consists of Java servlets which send presentation data to mobile client devices (e.g., the user interface engine of a thick client application). In addition, the Java servlets may be designed to act like controllers for the page or screen flows for pages sent to the mobile client device.

Presentation layer component 402 may include a page profile component configured to indicate to the mobile server the appropriate sequence of events to run to satisfy a particular request. In one embodiment, the page profile component is a configuration file installed in the mobile server that indicates a particular event sequence in an XML representation. The XML representation may be identified with a unique name in order to identify a specific request handling sequence. Preferably, the page profile includes a flow control mechanism configured for branching, conditional logic, and optional error handling. An event sequence includes tasks to be executed in a particular order. A page profile component is configured to specify which tasks to invoke, what parameters to pass to the tasks, what data to expect to receive in return from execution of the tasks, how to handle flow control after a task invocation, etc. In one embodiment, presentation layer component 402 preferably defines each screen in a device-independent presentation markup language such as pXML so that the screens provided for the client application user interface will work on a plurality of supported client devices.

Foundation layer component 404 is configured to be a point of exchange between the presentation layer component 402 and the integration manager (shown in FIG. 3). Foundation layer component 404 is configured to provide an interface to the presentation layer component 402 to invoke logic of the integration manager. In one embodiment, foundation layer component 404 consists of Java objects that facilitate communication between the presentation layer component 402 and other mobile server components that use different contexts such as the integration manager. Preferably, foundation layer component is configured to communicate with a plurality of generic process engines or other middleware packages as well as specific process engine or middleware packages.

Authentication management module 412 is configured to manage authentication and authorization of users and sessions with the mobile server. Preferably, all user and mobile client device access to the mobile server are authenticated and authorized. A directory server(s) 414 (e.g., LDAP or MS Active Directory) is coupled to the authentication management module 412 and is used to store and retrieve the credentials of users (e.g., login ID and password as well as authorization rules) in a directory database 416. A notification management module 408 is used to manage the distribution of notifications to a mobile client device. Notifications are messages that are sent to a mobile client device in response to events on the mobile server side, including events of backend systems. An event may be, for example, a business event such as orders added/deleted/changed, work orders completed, etc. or may be an administrative event such as system downtime notifications or any other types of events that a user may wish to receive. The notification framework provided on the mobile client device and the mobile server are configured to receive and send notifications asynchronously. Notification management module 408 may be configured to send, for example, email messages, SMS messages and sync notification messages. In one embodiment, notification management module 408 is configured to retrieve or rollback messages that are not confirmed (e.g., receipt of the message is not confirmed) by the mobile client device.

Synchronization management module 406 is provided to allow a mobile client device to support a client application which may be used while disconnected from a network. The synchronization framework is responsible for synchronizing data that was on the client device with the backend data. Synchronization occurs when a mobile client device goes from on network to off network to on network again and while off network the user 1) makes changes to data locally; or 2) the application has updates or a new version. Synchronization management module 406 may be configured to send HTTP messages between the mobile server and the mobile client device to transfer data and application updates. When a mobile client devices requests synchronization, the synchronization management module 406 queries a backend system to get the current version of the data in the backend. The current version of the data from the backend is then compared with the current version of the client data. Synchronization management module 406 then determines whether the client side data or backend data needs to be updated.

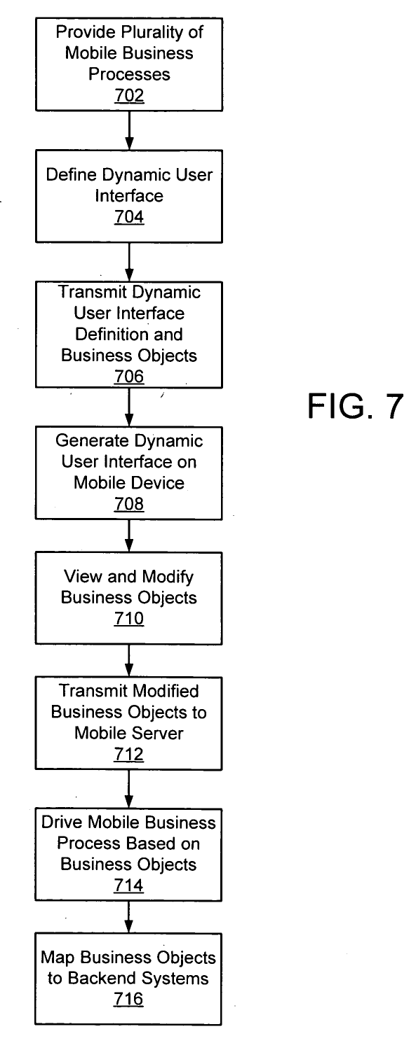

FIG. 7 illustrates a method for communication and mapping of business objects between mobile client devices and a plurality of backend systems in accordance with an embodiment. At block 702, as discussed above, a plurality of mobile business processes may be provided at a mobile server, in particular, a process automation engine of a mobile server. The mobile business processes define workflows that indicate how different tasks that a mobile user must perform and the data required for the tasks are collected, transformed and integrated with various backend systems. Accordingly, the mobile server is configured to communicate and map (or transform) business objects for various business processes between a mobile client device and the plurality of backend systems. At block 704, a dynamic user interface is defined at the mobile server and mapped to a plurality of business objects and mobile business processes. The dynamic user interface definition may be provided via communication module 112 and network 104 to the user interface 114 of a mobile client device 102 at block 706 along with the business objects. The dynamic user interface may be provided to the mobile client device before a business process is executed or during execution of the business process.

At block 708, the dynamic user interface is generated and executed on the mobile client device to facilitate the display and capture of data for mobile business processes. In addition, the rendered user interface is used to view and modify business objects utilized by the mobile business processes. At block 712, the mobile client device transmits modified business objects to the mobile server. As discussed above, the business objects may be transferred via a thin client application (e.g., Web browser) or via synchronization by a thick client application. At block 714, the business objects provided to the mobile server by the mobile client device are used to drive business processes. A business object is used to drive a mobile business process and specific data used in the mobile business process may trigger a request for data from a second backend system that may affect the business objects and data returned to the first backend system and/or the mobile client device. At block 716, data or a business object from the a mobile client device may be mapped to a first backend system having the required data. As discussed previously, data from a mobile client device may need to be transformed (or mapped) to be in the proper format for the backend system and vice versa.

While the embodiments, illustrated in the FIGURES and described above are presently preferred, it should be understood that these embodiments are offered by way of example only. Other embodiments may include additional procedures or steps not described here. The invention is not limited to a particular embodiment, but extends to various modifications, combinations, and permutations that nevertheless fall within the scope and spirit of the appended claims.

1. A system for communication and mapping of business objects between a mobile client device and a plurality of backend systems via a network, the system comprising:
a mobile server including:
a process automation engine configured to map business objects to the plurality of backend systems, the process automation engine including a plurality of mobile business processes, each mobile business process defining a flow and exchange of business objects between the mobile client device and at least one of the plurality of backend systems;
a communication module coupled to the process automation engine, the communication engine configured to receive and transmit business objects between the mobile client device and at least one of the plurality of mobile business processes via the network;
a presentation module coupled to the process automation engine and the communication module, the presentation module configured to define a dynamic user interface based on at least one mobile business process, the dynamic user interface configured to integrate the business objects and the at least one mobile business process; and
a mobile client device in data communication with the mobile server and including:
a thick client application in data communication with the communication module, the thick client application configured to receive the business objects and the definition of the dynamic user interface and configured to generate the dynamic user interface to facilitate viewing and modifying of the business objects.

2. A system according to claim 1, wherein the mobile server further includes an application builder coupled to the communication module and the process automation engine, the application builder configured to create dynamic forms which may be transmitted and presented on the mobile client device.

3. A system according to claim 2, wherein the application builder is further configured to define automatic logic that is used to drive the dynamic user interface on the mobile client device.

4. A system according to claim 2, wherein the application builder is further configured to define conditional logic that is used to drive the dynamic user interface on the mobile client device.

5. A system according to claim 2, wherein the application builder is further configured to define a set of data validation rules used to validate data entered in the dynamic forms presented on the mobile client device.

6. A system according to claim 1, wherein the mobile client device further includes a business object cache configured to provide a local cache of business objects on the mobile client device.

7. A system according to claim 1, wherein the business objects are formatted using extensible markup language(XML).

8. A system according to claim 1, wherein the mobile server further includes a business object database coupled to the process automation engine, the business object database configured to store business object records including a plurality of fields, wherein the status of a business object is indicated by a status field in the business object record.

9. A system according to claim 8, wherein the status field indicates whether data of the business object record has been changed.

10. A system according to claim 1, wherein the communication module is further configured to determine a connection status of the mobile client device.

11. A system according to claim 1, wherein the communication of business objects between the mobile client device and the process automation engine is a synchronous communication.

12. A system according to claim 1, wherein the communication of business objects between the mobile client device and the process automation engine is an asynchronous communication.

13. A system according to claim 1, wherein the mobile server further includes a notification management module coupled to the communication module and the plurality of backend systems, the notification management module configured to generate and transmit a message to the mobile client device.

14. A system according to claim 1, wherein mobile client device is configured to provide a notification to the notification management module that a message has been delivered.

15. A system according to claim 1, wherein the mobile server further includes a set of adapters coupled to the process automation engine, the plurality of adapters configured to provide integration to the plurality of backend systems.

16. A system according to claim 1, further comprising a directory server coupled to the communication module and the presentation module, the directory server configured to authenticate authorization information provided by the mobile client device.

17. A system according to claim 1, wherein the mobile client device further includes a client application database configured to store tables including data used to drive the dynamic user interface.

18. A system according to claim 1, wherein the dynamic user interface is defined using one of extensible markup language (XML), dynamic hypertext markup language (DHTML), Java Server Pages (JSP), a scripting language, or a compiled module.

19. A system according to claim 1, wherein the dynamic user interface includes a plurality of screens having a plurality of data fields and a plurality of display fields.

20. A system according to claim 1, wherein the communication module is further configured to marshall the business objects.

21. A system according to claim 1, wherein the dynamic user interface is defined to facilitate receipt of data used to drive a mobile business process.

22. A system according to claim 1, wherein the network is the Internet.

23. A system according to claim 1, wherein the mobile client device is connected to the network via a wireless connection.

24. A system according to claim 1, wherein the mobile client device is connected to the network via a wired connection.

25. A system according to claim 2, wherein the application builder is configured to create form sequences which may drive a centralized form definition.

26. A system according to claim 2, wherein the application builder is configured to dynamically create tables of data based on the dynamic forms.

27. A system according to claim 1 wherein the mobile client device further includes a database configured for local caching of business objects.

28. A system according to claim 1, wherein the presentation module is configured to convert business objects received from the mobile client device from a compressed form to extensible markup language (XML).

29. A system according to claim 13, wherein the notification management module is further configured to recall messages that have not been confirmed by the mobile client device.

30. A system according to claim 1, wherein a delivery of business objects from the mobile server to the mobile client device is integrated with the plurality of business processes.

31. A system according to claim 1, wherein a single login process may be implemented for both the mobile client device and the mobile server.

32. A system according to claim 1, wherein the communication module is configured to receive and transmit data using a secure transmission technique.

33. A system according to claim 1, wherein the communication module is configured to process compressed data for use with a wireless network.

34. A method for communication and mapping of business objects between a mobile client device and a plurality of backend systems via a network, the method comprising:
providing a plurality of mobile business processes, each mobile business process defining a flow and exchange of business objects between the mobile client device and at least one of the plurality of backend systems;
defining a dynamic user interface based on at least one mobile business process, the dynamic user interface configured to integrate the business objects and the at least one mobile business process;
transmitting the dynamic user interface definition and business objects to the mobile client device; and
executing the dynamic user interface on the mobile client device to facilitate viewing and modifying of the business objects.

35. A method according to claim 34, further comprising creating a set of dynamic forms which may be transmitted to and presented on the mobile client device.

36. A method according to claim 34, further comprising defining automatic logic that is used to drive the dynamic user interface on the mobile client device.

37. A method according to claim 34, further comprising defining conditional logic that is used to drive the dynamic user interface on the mobile client device.

38. A method according to claim 35, further comprising defining a set of data validation rules used to validate data entered in the dynamic forms presented on the mobile client device.

39. A method according to claim 34, wherein the dynamic user interface is defined to facilitate receipt of data used to drive a mobile business process.

40. A method according to claim 34, wherein the communication of business objects between the mobile client device and the plurality of mobile backend systems is a synchronous communication.

41. A method according to claim 34, wherein the communication of business objects between the mobile client devices and the plurality of backend systems is an asynchronous communication.

42. A method according to claim 34 further comprising:
generating notification messages;
transmitting notification messages to the mobile client device; and
receiving acknowledgements of receipt from the mobile client device.

43. A method according to claim 34, wherein the dynamic user interface includes a plurality of screens having a plurality of data fields and a plurality of display fields.
